(19) United States
(12) Patent Application Publication
(10) Pub. No.: US 2024/0261860 A1
(43) Pub. Date: Aug. 8, 2024

(54) METHOD FOR MANUFACTURING A PLURALITY OF COMPONENTS DURING AN ADDITIVE MANUFACTURING PROCESS

(71) Applicant: Brose Fahrzeugteile SE & Co. Kommanditgesellschaft, Würzburg, Würzburg (DE)

(72) Inventor: Jan SANDER, Meeder (DE)

(73) Assignee: Brose Fahrzeugteile SE & Co. Kommanditgesellschaft, Würzburg, Würzburg (DE)

(21) Appl. No.: 17/800,927

(22) PCT Filed: Feb. 15, 2021
(86) PCT No.: PCT/EP2021/053618

§ 371 Date: Oct. 24, 2022

(30) Foreign Application Priority Data
Feb. 20, 2020 (DE) 10 2020 104 541.7

(51) Int. Cl. B22F 10/28; B23K 26/342; B33Y 10/00

(52) U.S. Cl. CPC B22F 10/28; B23K 26/342; B33Y 10/00; B22F 2998/10

(57) ABSTRACT

Methods of manufacturing a plurality of components during an additive manufacturing process by means of a powder including particles, which is at least locally melted in order to form the plurality of components. The plurality of components can be formed in a component layer extending along a manufacturing plane, in which a first component lies adjacent to a second component of the component layer at least in a spatial direction along the manufacturing plane. In this connection it is proposed to provide a gap having a gap width between the first component and the second component of the component layer, which is predefined using a particle size distribution of the particles in the powder.

### CROSS-REFERENCE TO RELATED APPLICATIONS

This application is the U.S. National Phase of PCT Application No. PCT/EP2021/053618 filed on Feb. 15, 2021, which claims priority to German Patent Application No. DE 10 2020 104 541.7, filed on Feb. 20, 2020, the disclosures of which are hereby incorporated in their entirety by reference herein.

### TECHNICAL FIELD

The present disclosure relates to a method for manufacturing a plurality of components during an additive manufacturing process.

### BACKGROUND

It is known to manufacture a plurality of components by additive laser melting. In this process, the components are built up in a powder bed layer by layer. For forming the plurality of components, the powder is melted at least locally in order to manufacture the plurality of components in at least one component layer extending along a manufacturing plane, in which a first component is present in a spatial direction adjacent to at least one second component.

To fix the components to be manufactured in the powder bed, such as against possible distortions, and to dissipate excess heat, supporting structures are formed at the same time, e.g. from the same material as the component itself, i.e. in particular from metal. As the supporting structures are needed merely during the manufacturing process, the same are removed again after the additive manufacture, usually manually. The entire process thereby becomes comparatively expensive and costly.

### SUMMARY

Against this background it is the object underlying the proposed solution to further improve a manufacturing method.

According to a first aspect of the proposed solution, a gap having a gap width is provided between the first component and the second component of the component layer, which gap is predefined using a particle size distribution of the particles in the powder.

The idea underlying the proposed solution in this respect is to provide a support of the first and second components lying adjacent to each other across particles present in the gap. Due to the dimensioning of the gap width oriented on the particle size distribution, the distance between the components can be set in a particle-related way without providing a separate supporting structure, namely for example, in such a way that, when a force is transmitted between the components during the manufacturing process, for example due to distortion, there will be no displacement of the particles present in the gap and hence a displacement of the components relative to each other. The function of a separately formed supporting structure thus can be assumed by the particles of the powder used for forming, which particles are present in the gap. Thus, the manufacturing process does not require a supporting structure as an independent geometry, and a supporting structure need not be manufactured additively in the manufacturing process.

In one design variant, the gap width is predefined on the basis of the particle size distribution, and the gap width determines the mean distance of the first component to the (directly) adjacent second component in the manufacturing plane during the formation of the first and second components. In a powder bed used for manufacture, the first and second components thus are separated from each other merely by the gap when the manufacturing process is completed.

For example, the gap width set corresponds to a mean particle size of the particles in the powder. The mean particle size for the gap width for example can correspond to a value of the particle size distribution which lies in the range between the d90 value and the d100 value—such as +10%. As an another example, the mean particle size for the gap width can correspond to the d90 value or d95 value of the particle size distribution. What is meant by gap width corresponding to a mean particle size of d90 or d95 of the particle size distribution for example is the fact that the gap width corresponds to that diameter of the particles in the powder which is not exceeded by 90% (d90) or 95% (d95) of the particles present in the powder. In other words, 90% or 95% of the particles in the powder have a diameter which is equal to or less than the d90/d95 value.

Within the component layer, the first component can be present in two mutually perpendicular spatial directions along the manufacturing plane adjacent to second components, which each are spaced apart from the first component by a gap width. In this way, the first component hence can be enclosed within the powder between a plurality of (at least two) second components, with a support each being effected across a gap whose gap width is predefined using the particle size distribution of the particles in the powder. For example, the first component can be arranged centrally between four second components of a component layer along two mutually perpendicular spatial axes.

In principle, the first and second components can form part of a first component layer of a component block, wherein at least one second component layer of the component block for further components to be formed from the powder extends parallel to the first component layer. Thus, the component block comprises at least two component layers in which a plurality of components each are present one beside the other at the end of the manufacturing process. Within the component block, a plurality of layers each having rows of components thus are present at the end of the additive manufacturing process.

In principle, the first and second components as well as the components of different component layers can be formed identically so that via the additive manufacturing process a component block comprising a plurality of identical components is additively manufactured from the powder.

According to another aspect of the proposed solution, which can be used in a proposed method alternatively or in addition to the first aspect, a sinter bridge layer is formed between the components of a first and a second component layer for arresting at least two components of different component layers to each other during the manufacturing process.

During the additive manufacturing process, this sinter bridge layer produces a cohesive connection between components of different component layers. This cohesive connection here is designed in such a way that it will fail specifically for a removal of a component from a component block comprising at least the first and second component layers—by action of a force applied manually or via a removal robot—, so that the components of the different component layers are to be separated from each other along the sinter bridge layer. For example, the sinter bridge layer therefor is formed thin and brittle during the additive manufacturing process so that it will fail upon action of a force above a predefined threshold value. The sinter bridge layer hence is provided merely for the temporary fixation during the additive manufacturing process and therefor is then formed comparatively thin. For forming the sinter bridge layer during the additive manufacturing process, the powder used for the manufacture is correspondingly melted via preset process parameters, i.e. for example is exposed correspondingly.

For example, the sinter bridge layer has a (layer) thickness which corresponds to merely a fraction of a layer thickness of a component layer, which is predefined by the height of the components in this component layer. For example, when components of a predetermined height are built up layer by layer one on top of the other in a component layer, the layer thickness corresponds to the maximum height of its components. For example, the thickness of the sinter bridge layer which connects components of two component layers to each other, amounts to maximally 1/10, maximally 1/20 or maximally 1/40 of the layer thickness of a component layer. In one design variant, the sinter bridge layer can, however, also be dimensioned in relation to the mean thickness of the melting paths of melted powder, from which the components are built up layer by layer. For example, the thickness of the sinter bridge layer lies in the range of 1 to 15 melting path thicknesses, such as in the range of 5 to 10 melting path thicknesses. Hence, when a component is built up layer by layer from melting paths of a mean melting path thickness x, the (layer) thickness of the sinter bridge layer e.g. lies in the range of x to 15×, for example, in the range of 5× to 10×.

In one design variant of the proposed solution, the formation of the plurality of components is effected by additive laser melting. In this variant, the formation of the components consequently is effected in a powder bed by at least locally melting the powder bed by means of at least one laser.

In a design variant combining the two aforementioned aspects, the first and second components are arrested within their component layer (with respect to the associated manufacturing plane) via the gap width predefined with reference to the particle size distribution, while on at least one of these first and second components an additional arrestment to at least one component of a further component layer and hence perpendicularly to the manufacturing plane of the first and second component layers is effected via the sinter bridge layer. Thus, while a support and hence arrestment of the components to be manufactured for example is ensured during the additive manufacturing process in an xy-manufacturing plane via the gap width correspondingly predefined in a particle-related way, the sinter bridge layer produced during the additive manufacturing process each effects an arrestment perpendicularly thereto, i.e. for example along a z-axis. As a result, the fixation of a (first) component in the x-direction and y-direction thus can be effected by the respectively adjacent (second) components, wherein the force transmission is effected via the particles of a thick powder layer within the separating gap. For the fixation of the components across a plurality of superimposed component layers loose sintering is provided via the sinter bridge layer. Analogously to the force transmission, a heat dissipation can be effected via the powder layer in the gap or the component gap defined therewith between components of a component layer and via the sinter bridge layer between the component layers.

### BRIEF DESCRIPTION OF THE DRAWINGS

The attached Figures by way of example illustrate possible design variants of the proposed solution.

In the drawings:

FIG. 1 in part and in a sectional view shows component layers of a component block comprising a plurality of components additively formed one beside the other and on top of the other according to a design variant of the proposed manufacturing method;

FIG. 2 shows a detail representation cut out from FIG. 1 of two superimposed components, which are arrestingly connected to each other via a loose sintering provided by a sinter bridge layer;

FIG. 2A shows an enlarged section of the detail representation of FIG. 2;

FIG. 3 on an enlarged scale shows two components located one beside the other in a component layer, between which there is formed a gap which has a gap width of exactly one particle of a powder used for manufacture;

FIGS. 4A-4B in a view corresponding with FIG. 3 show the two components lying one beside the other and separated by a gap, wherein here the gap each is not predefined too small (FIG. 4A) or too large (FIG. 4B) corresponding to the proposed solution;

FIG. 5 shows a perspective view of a component block manufactured corresponding to a design variant of the proposed solution, comprising a plurality of superimposed components which each have a plurality of rows of identically formed components lying one beside the other.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

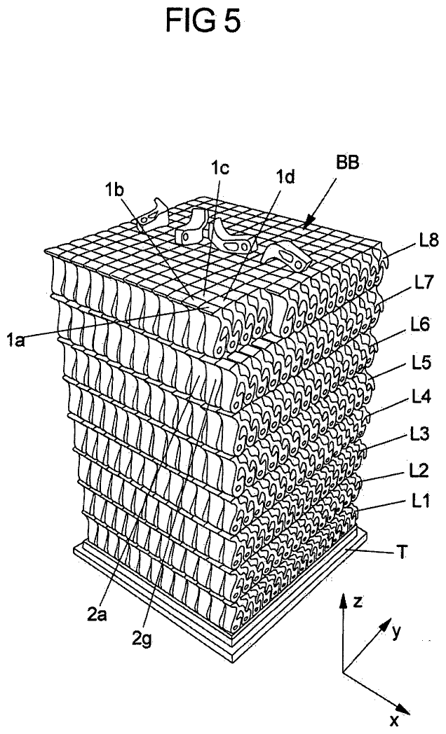

FIG. 5 shows a perspective view of a cuboid component block BB which has been obtained by additive manufacture—here by additive laser melting—in a powder bed. The component block BB comprises a plurality of, here eight, component layers L1 to L8, which lie one on top of the other on a carrier platform T along a spatial direction z. Each component layer L1 to L8 extends along a manufacturing plane which in the present case is defined along spatial directions x and y each extending perpendicularly to the z-direction. In each component layer L1 to L8 a plurality of identical components are arranged lying one beside the other in rows along the two spatial directions x and y.

By way of example, an edge-side (first) component 1a is shown in an uppermost component layer L8, adjacent to which second components 1b to 1d lie within the same component layer L8. In an underlying component layer L7 identically shaped components are formed, of which a component 2a is provided directly below the first component 1a, on which the first component 1a rests at the end of the additive manufacturing process. The component 2a of the underlying component layer L7 correspondingly likewise lies adjacent to further identical components, such as for example a second component 2g.

In the component block BB shown in FIG. 5, the individual components 1a to 1d, 2a and 2g are formed in a powder without supporting structures. For this purpose, component gaps in the form of gaps g each are provided on the one hand between components of a component layer L1 to L8 and hence between components lying directly adjacent to each other in an xy-manufacturing plane along the spatial directions x and y. Via a gap g two adjacent components are spaced apart from each other by a gap width s, which is predefined using a particle size distribution of the particles P1 to P5 present in the powder of the powder bed. On the other hand, mutually adjacent components of different component layers L1 to L8 are connected to each other for the additive manufacturing process via a loose sintering provided by means of a sinter bridge layer 12. The chosen particle-related gap width s between the components of a component layer L1 to L8 ensures a support and hence arrestment of the components to be formed in the x-direction and y-direction, while the sinter bridge layers 12 between the component layers L1 to L8 ensure an arrestment in the z-direction during the additive manufacturing process.

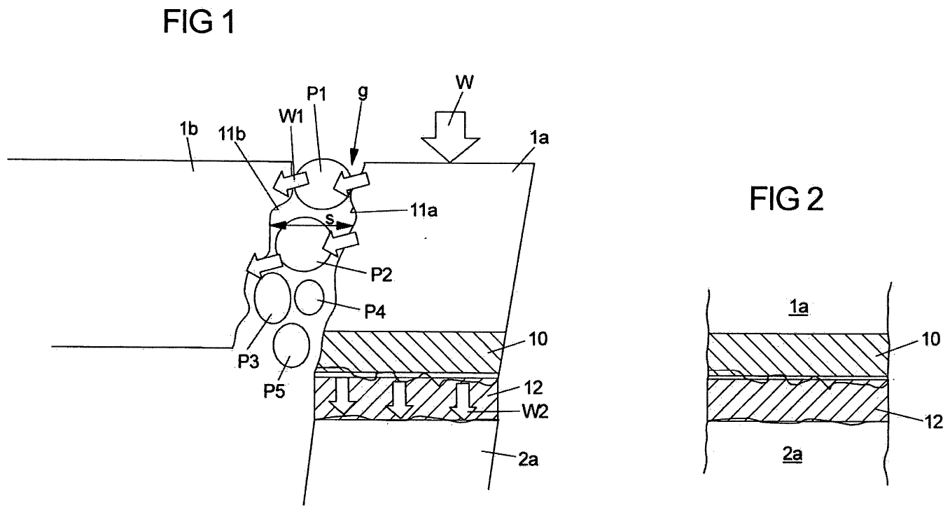

On an enlarged scale, FIG. 1 illustrates a gap g between two components 1a and 1b lying adjacent to each other in a component layer L8. The (first) component 1a here is shown connected to a component 2a of an underlying component layer L7 via a sinter bridge layer 12. The gap width s of the gap g between the first component 1a and the adjoining component 1b of the same component layer L8 is predefined in dependence on a particle size distribution of the particles P1 to P5 present in the powder bed. The predefined gap width s for example corresponds to a mean particle size d95 of the particle size distribution, so that the gap width s of the gap g between the components 1a and 1b corresponds to a mean diameter d which is not exceeded by 95% of the particles P1 to P5 present in the powder bed. In this way, it can be achieved that in the gap g a powder layer having a width of exactly one particle is present and hence a force transmission between the components 1a, 1b is effected via exactly one particle P1 within the gap g. In this way, a force can be transmitted directly via individual particles P1 to P5 without the (powder) particles P1 to P5 being shifted relative to each other.

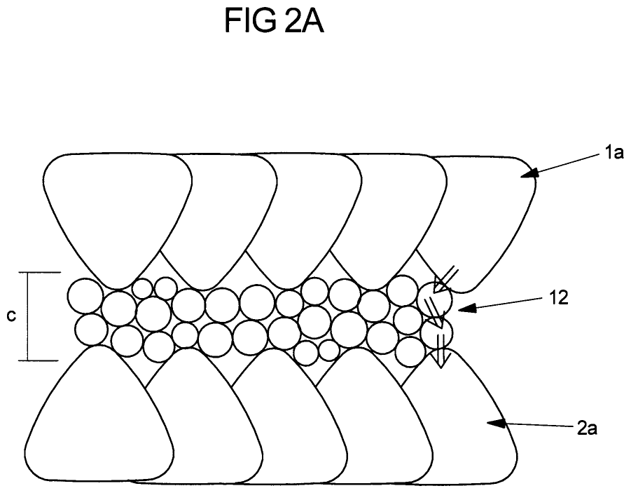

For the arrestment along the z-direction, the sinter bridge layer 12 is formed during the additive manufacturing process on a base layer 10 of a component 1a, which as basis of the component 1a faces the underlying component 2a of the underlying component layer. The loose sintering provided via this sinter bridge layer 12 here is formed by correspondingly set process parameters and forms a temporary positive connection between the components 1a, 2a of successive component layers, here of the component layers L7 and L8. The sinter bridge layer 12 corresponding to FIG. 2, which is formed by corresponding exposure during the additive laser melting, here—as in turn shown in FIG. 1—not only serves the arrestment in the z-direction during the additive manufacturing process, but also serves a defined heat transfer W2 between the components 1a, 2a during a heat input W into one of the components 1a, 2a. During a heat input W, the particles P1 to P5 in the gap g furthermore also ensure a heat transfer W1 within the same component layer.

The enlarged representation of FIG. 2A in particular shows that a thickness c of the sinter bridge layer 12 merely corresponds to a fraction of the height in the z-direction and hence only to a fraction of a layer thickness of a component layer L1 to L8. In the present case, the thickness c of the sinter bridge layer 12 lies in a range which corresponds to two to ten times a mean thickness of the melting paths by means of which the components of the component layers L1 to L8 are additively built up layer by layer. The thickness c of the sinter bridge layer 12 depends on the input of energy into the respective lowermost melting path of the component lying above the formed sinter bridge layer 12 (hence e.g. in FIG. 2A on the input of energy into the lowermost melting path of the component 1a). When the manufacture of the components 1a and 2a for example is effected from an aluminum powder, a gap of about 5 to 10 melting paths (melting path thicknesses) is present between the two components 1a and 2a in the region of the sinter bridge layer 12 to be formed.

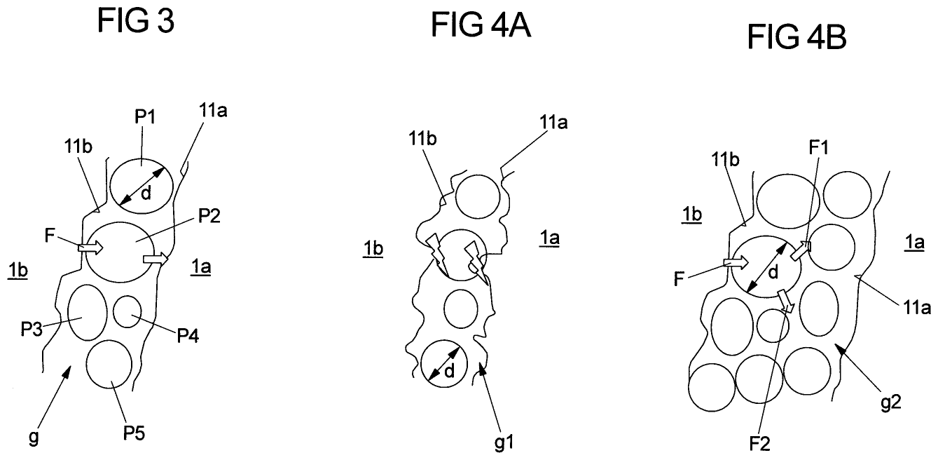

The enlarged representation of FIG. 3 once again illustrates the transmission of a force F between mutually adjacent components 1a and 1b of a component layer via the individual particles P1 to P5 in a component gap which is predefined by the gap g. Via an individual particle P1, the force F is transmitted on side faces 11a, 11b of the two components 1a, 1b facing each other. The components 1a and 1b thus can be supported on each other without any supporting structure via the component gap having a width of one particle, namely without the components 1a, 1b of the same component layer being connected to each other.

When the gap width s of the gap g on the other hand, as shown in FIG. 4A, is chosen too small, there is a risk that the components 1a, 1b directly are positively connected to each other, which not only can lead to undesired tensions, but also to deformations. When the gap width s is too large, as shown in FIG. 4B, an introduced force F in turn can be transmitted from a particle of the powder layer into adjoining particles as a (partial) force F1 or F2. This can then lead to a displacement of the particles and hence to a displacement of the adjoining component. An arrestment of the components in the xy-manufacturing plane here consequently is not ensured.

The targeted definition of the gap width s for mutually adjacent components 1a, 1b and the component gap obtained during the additive manufacturing process by using the particle size distribution provides for arresting the components within a component block BB to be manufactured without using any supporting structures. This reduces the process costs due to a reduction of the exposure time. The material consumption also is reduced when no separate supporting structures have to be formed as well. As no supporting structures have to be removed subsequently, the costs for post-processing the additively manufactured component also are reduced. Moreover, the utilization of the (manufacturing) space provided for manufacture via the carrier platform T is improved.

Components manufactured by way of example with a design variant of the proposed manufacturing method for example can include vehicle parts, in particular parts for a vehicle seat, such as a seat height stop, a seat bracket or a cam for a seat adjusting mechanism.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE NUMERALS

1a-1d, 2a, 2g component
10 base layer
11a, 11b side face
12 sinter bridge layer
BB component block
C layer thickness
d diameter
F, F1, F2 force
g, g1, g2 gap
L1-L8 component layer
P1-P5 particle
S gap width
T carrier platform
W heat input
W1, W2 heat transfer

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method of manufacturing a plurality of components during an additive manufacturing process by means of a powder including particles, the method comprising:
at least locally melting the particles to form the plurality of components;
forming a first component layer extending along a manufacturing plane, in which a first component of the plurality of components is present at least in a spatial direction along the manufacturing plane and adjacent to a second component of the plurality of components,
wherein a gap having a gap width is formed
between the first and second components of the plurality of components disposed in the first component layer, wherein the gap width is predefined using a particle size distribution of the particles in the powder.

2. The method of claim 1, wherein the gap width is predefined based on the particle size distribution and determines a mean distance between the first component and the second component.

3. The method of claim 1, wherein the gap width corresponds to a mean particle size of the particles in the powder.

4. The method of claim 3, wherein the mean particle size for the gap width corresponds to a value of the particle size distribution ranging between d90 and d100+10%.

5. The method of claim 1, wherein the first component of the plurality of components is present in two mutually perpendicular spatial directions along the manufacturing plane adjacent to second components of the plurality of components, each are spaced apart from the first component by the gap width.

6. The method of claim 1, wherein the first and second components form part of the first component layer of a component block, the first component layer parallel to a second component layer of the component block extends for further components to be formed from the powder.

7. A method for manufacturing a plurality of components during an additive manufacturing process by means of a powder including particles, the method comprising:
forming a plurality of components by at least locally melting the particles one on top of the other to form at least two component layers extending parallel to each other, so that a first component of the plurality of components of disposed in a first component layer is formed above a second component disposed in a second component layer; and
arresting the first and second components plurality of components disposed in the first and second component layers to each other during the additive manufacturing process, by forming a sinter bridge layer between the first and second components of the plurality of components.

8. The method of claim 7, wherein the arresting step includes forming the sinter bridge layer to have a thickness which corresponds to a fraction of a layer thickness of a component layer that is predefined by the height of the plurality of components of disposed in each of the respective component layers.

9. The method of claim 1, wherein the forming step is effected by additive laser melting.

10. The method of claim 1, further comprising:
arresting the first component within the first component layer and arresting the second component within the second component layer via the gap width.

11. The method of claim 3, wherein the mean particle size for the gap width corresponds to a value of the particle size distribution ranging between d90 or d95.

12. The method of claim 10, further comprising:
forming a sinter bridge layer on the first and second components.

13. The method of claim 12, wherein the forming the sinter bridge layer results in additional arrestment of the first and second components.

14. A method of additive manufacturing a number of components, the method comprising:
providing a powder, the powder formed of particles;
forming a first component layer extending along a manufacturing plane,
forming a first component of the number of components, the first component disposed in the first component layer; and
forming a second component of the number of components, the first component and the second component disposed in a spatial direction along the manufacturing plane and adjacent to one another, wherein the first and second components of the number of components are spaced apart by a gap having a gap width, wherein the gap width is based on a particle size distribution of the particles.

15. The method of claim 14, wherein the first and second components are spaced apart by a mean distance.

16. The method of claim 14, further comprising:
determining a range of a mean particle size of the particles in the powder, wherein the gap width is based on the mean particle size of the particles.

17. The method of claim 16, wherein the mean particle size for the gap width corresponds to a value of the particle size distribution ranging between d90 and d100+10%.

18. The method of claim 14, further comprising:
forming a second component layer extending parallel to the first component layer; and
forming a third component of the number of components in the second component layer.

19. The method of claim 18, further comprising:
forming a sinter bridge layer between the second and the third components of the plurality of components.

20. The method of claim 19, wherein the forming the sinter bridge layer includes arresting the second and third components of the plurality of components.
